(19) United States
(12) Patent Application Publication
(10) Pub. No.: US 2024/0233981 A9
(43) Pub. Date: Jul. 11, 2024

(54) WATER-PROOF STRUCTURE FOR ELECTRIC WIRE AND WATER-PROOF METHOD FOR ELECTRIC WIRE

(71) Applicant: Yazaki Corporation, Tokyo (JP)

(72) Inventors: Eiichi TOHYAMA, Shizuoka (JP); Michitake Masuda, Shizuoka (JP); Hideyuki Wada, Shizuoka (JP)

(73) Assignee: Yazaki Corporation, Tokyo (JP)

(21) Appl. No.: 18/490,336

(22) Filed: Oct. 19, 2023

(30) Foreign Application Priority Data
Oct. 24, 2022 (JP) 2022-169671

(51) Int. Cl. H01B 7/285; H01B 13/06

(52) U.S. Cl. CPC H01B 7/285; H01B 13/062

(57) ABSTRACT

A water-proof structure for electric wire includes an electric wire, a primary molded body, and a secondary molded body. The electric wire includes a core wire exposed part in which a core wire is exposed by peeling off an insulation sheath. The primary molded body is molded with resin and includes a groove portion for receiving therein an end portion of the electric wire including the core wire exposed part. The secondary molded body is molded with resin and covers the primary molded body in a state where the end portion of the electric wire is received in the groove portion.

### CROSS-REFERENCE TO RELATED APPLICATIONS

The present application is based on and claims the benefit of priority from the prior Japanese Patent Application No. 2022-169671, filed on Oct. 24, 2022, the entire contents of which are incorporated by reference herein.

### TECHNICAL FIELD

The disclosure relates to a water-proof structure for electric wire and a water-proof method for electric wire.

### BACKGROUND

As a conventional water-proof structure for electric wire, there has been known a water-proof structure for electric wire described in Patent Document 1 (JP 2009-152012 A). In the water-proof structure for electric wire described in Patent Document 1, a heat-shrinkable tube is put over an intermediate portion of an electric wire which includes a core wire exposed part where an insulation sheath of the electric wire is peeled off and two parts of the insulation sheath adjacent to the core wire exposed part. Then, the heat-shrinkable tube is heated to melt a heat-melting water-proof agent laminated inside the heat-shrinkable tube, which allows the heat-melting water-proof agent to penetrate among a plurality of strands of a core wire in the core wire exposed part.

### SUMMARY

However, the conventional water-proof structure for electric wire requires a process in which the heat-shrinkable tube is heated to shrink, which causes variations depending on conditions, resulting in quality issues. Further, because the process relies on human labors, it cannot be labor-saving and is therefore more expensive. Furthermore, it cannot be used under environmental conditions where the heat-melting water-proof agent in an inner layer of the heat-shrinkable tube melts before it is heated.

The disclosure has been made in view of such a conventional problem, and it is an object of the disclosure to provide a water-proof structure for electric wire and a water-proof method for electric wire that can improve quality and reduce labors and costs.

A water-proof structure for electric wire in accordance with a first aspect includes: an electric wire that includes a core wire exposed part in which a core wire is exposed by peeling off an insulation sheath; a primary molded body that is molded with resin and includes a groove portion for receiving therein a part of the electric wire, the part of the electric wire including the core wire exposed part; and a secondary molded body that is molded with resin and covers the primary molded body in a state where the part of the electric wire is received in the groove portion.

A water-proof method for electric wire in accordance with a second aspect includes: peeling off an insulation sheath of an electric wire to form a core wire exposed part in which a core wire is exposed; connecting a lead wire of an electronic component to the core wire exposed part of the electric wire; mold-forming with resin a primary molded body including a groove portion for receiving therein a part of the electric wire, the part of the electric wire including a connection portion of the core wire exposed part and the lead wire of the electronic component; setting the part of the electric wire including the connection portion of the core wire exposed part and the lead wire of the electronic component in the groove portion of the primary molded body; and mold-forming with resin a secondary molded body such that the resin is injected in the groove portion of the primary molded body to seal with the resin the part of the electric wire including the connection portion of the core wire exposed part and the lead wire of the electronic component.

A water-proof method for electric wire in accordance with a third aspect includes: peeling off an insulation sheath of an electric wire in a part of an intermediate portion of the electric wire in a length direction of the electric wire to form a core wire exposed part in which a core wire including a plurality of strands is exposed; mold-forming with resin a primary molded body including a groove portion for receiving therein the intermediate portion of the electric wire including the core wire exposed part; setting the intermediate portion of the electric wire including the core wire exposed part in the groove portion of the primary molded body; applying an adhesive agent to the core wire exposed part set in the groove portion of the primary molded body such that the adhesive agent penetrates between the strands to seal a gap between the strands; and mold-forming with resin a secondary molded body such that the resin is injected in the groove portion of the primary molded body to seal with the resin the intermediate portion of the electric wire including the core wire exposed part.

According to the disclosure, it is possible to provide a water-proof structure for electric wire and a water-proof method for electric wire that can improve quality and reduce labors and costs.

### BRIEF DESCRIPTION OF DRAWINGS

FIG. 1 is a plan view illustrating one example of an electric wire assembly used in a water-proof structure for electric wire according to a first embodiment.

FIG. 2 is a plan view of a primary molded body used in the water-proof structure for electric wire according to the first embodiment.

FIG. 3A is a cross-sectional view of one mode of the primary molded body along a III-III line in FIG. 2.

FIG. 3B is a cross-sectional view of another mode of the primary molded body along the III-III line in FIG. 2.

FIG. 4A is a perspective view of a protective cap used in the water-proof structure for electric wire according to the first embodiment, viewed from a front side thereof.

FIG. 4B is a perspective view of the protective cap according to the first embodiment, viewed from a back side thereof.

FIG. 5 is a perspective view illustrating a state where the electric wire assembly is received in a groove portion of the primary molded body according to the first embodiment.

FIG. 6 is a plan view illustrating a state where the electric wire assembly is received in the groove portion of the primary molded body according to the first embodiment before mold-forming using a mold.

FIG. 7 is a partly enlarged perspective view illustrating a state where the protective cap is mounted in the primary molded body according to the first embodiment.

FIG. 8 is a perspective view of the water-proof structure for electric wire according to the first embodiment.

FIG. 9A is a cross-sectional view of the water-proof structure for electric wire along an A-A line in FIG. 8.

FIG. 9B is a cross-sectional view of the water-proof structure for electric wire along a B-B line in FIG. 8.

FIG. 9C is a cross-sectional view of the water-proof structure for electric wire along a C-C line in FIG. 8.

FIG. 9D is a cross-sectional view of the water-proof structure for electric wire along a D-D line in FIG. 8.

FIG. 10A is a plan view illustrating a state before mold-forming of a water-proof structure for electric wire according to a modified example of the first embodiment.

FIG. 10B is a plan view illustrating a state after mold-forming of the water-proof structure for electric wire according to the modified example of the first embodiment.

FIG. 11 is a perspective view illustrating one example of an electric wire used in a water-proof structure for electric wire according to a second embodiment.

FIG. 12 is a perspective view of a primary molded body used in the water-proof structure for electric wire according to the second embodiment.

FIG. 13A is a cross-sectional view of one mode of the primary molded body along a XIII-XIII line in FIG. 12.

FIG. 13B is a cross-sectional view of another mode of the primary molded body along the XIII-XIII line in FIG. 12.

FIG. 14 is a perspective view illustrating a state where the electric wire is received in a groove portion of the primary molded body according to the second embodiment before mold-forming using a mold.

FIG. 15 is a cross-sectional view of a main part in a state where the electric wire is received in the groove portion of the primary molded body according to the second embodiment.

FIG. 16 is a perspective view of the water-proof structure for electric wire according to the second embodiment.

FIG. 17A is a cross-sectional view of the water-proof structure for electric wire along an A-A line in FIG. 16.

FIG. 17B is a cross-sectional view of the water-proof structure for electric wire along a B-B line in FIG. 16.

FIG. 18A is a plan view illustrating a state before mold-forming of a water-proof structure for electric wire according to a modified example of the second embodiment.

FIG. 18B is a plan view illustrating a state after mold-forming of the water-proof structure for electric wire according to the modified example of the second embodiment.

### DETAILED DESCRIPTION

Hereinafter, a water-proof structure for electric wire and a water-proof method for electric wire according to embodiments will be described in detail with reference to the drawings.

### First Embodiment

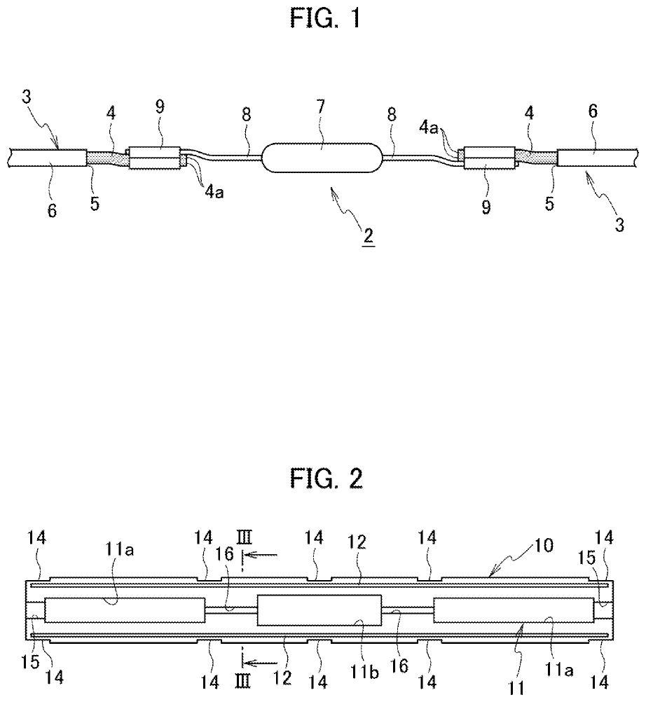

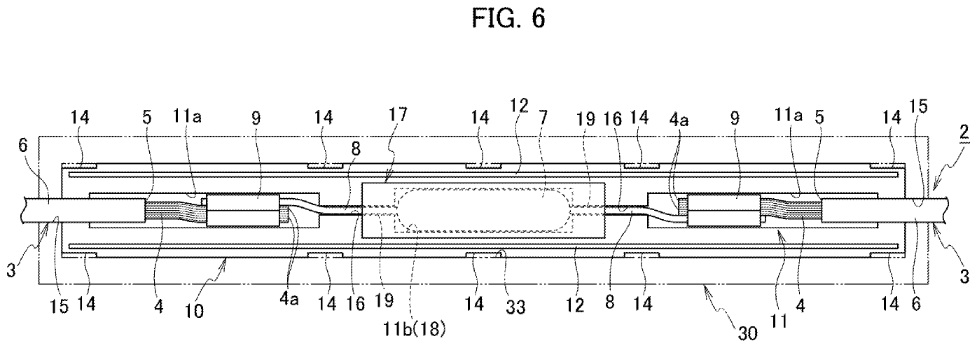

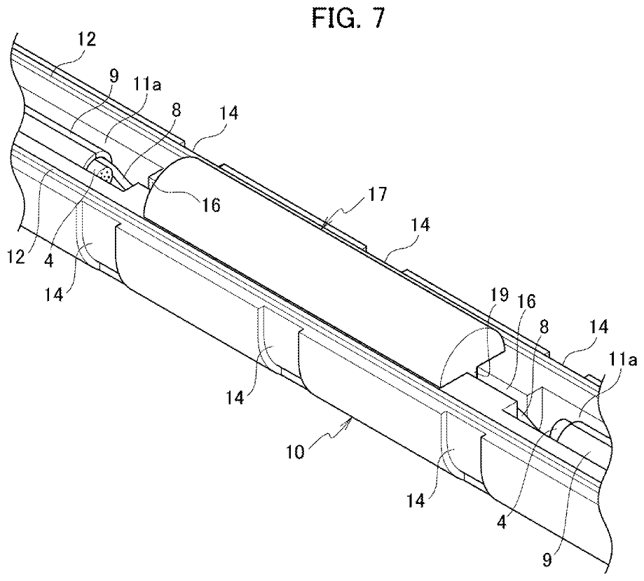

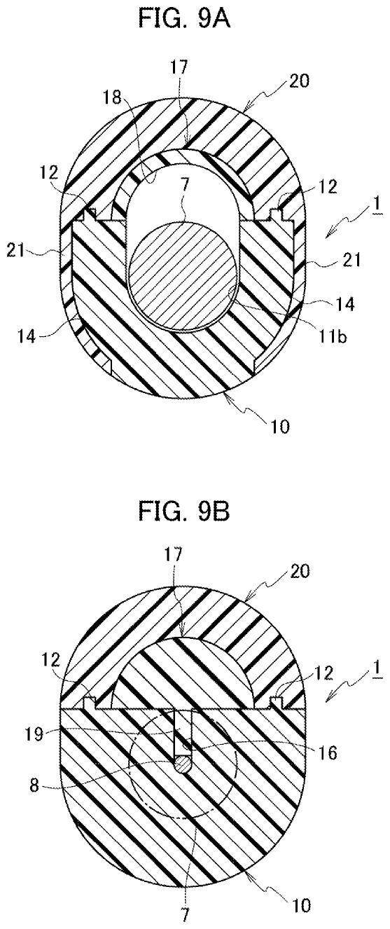

As illustrated in FIG. 1 and FIG. 5, an electric wire assembly 2 used in a water-proof structure 1 for electric wire includes a pair of electric wires 3, 3, and a resistor (electronic component) 7 disposed between the end portions of the electric wires 3, 3. As illustrated in FIG. 6 and FIG. 8, the water-proof structure 1 for electric wire includes the electric wire assembly 2, a primary molded body 10 molded with resin, and a secondary molded body 20 molded with resin such that the secondary molded body 20 covers the primary molded body 10 of which the electric wire assembly 2 is received in a groove portion 11 extending along a length direction. One of the electric wires 3, 3 of the water-proof structure 1 for electric wire is connected to a device such as an ECU (Electric Control Unit) performing a control or the like of a plurality of electric components mounted in a vehicle (not illustrated). The other of the electric wires 3, 3 of the water-proof structure 1 for electric wire is connected to a component such as a non-water-proof terminal.

As illustrated in FIG. 1, each of the electric wires 3, 3 of the electric wire assembly 2 includes a core wire 4 in which a plurality of strands 4a is twisted, and an insulation sheath 6 made of insulation resin covering the core wire 4. Each of the end portions of the electric wires 3, 3 facing each other has a core wire exposed part 5 where the insulation sheath 6 is peeled off and the core wire 4 is exposed. The core wire exposed parts 5, 5 are electrically connected to lead wires 8, 8 extending outward from both ends of the resistor 7 via conductive joint terminals 9, 9 by fixing the lead wires 8, 8 to the core wire exposed parts 5, 5 with the joint terminals 9, 9 by applying pressure. The core wires 4, 4 are made of a metallic material such as copper, copper alloy, or aluminum alloy, for example.

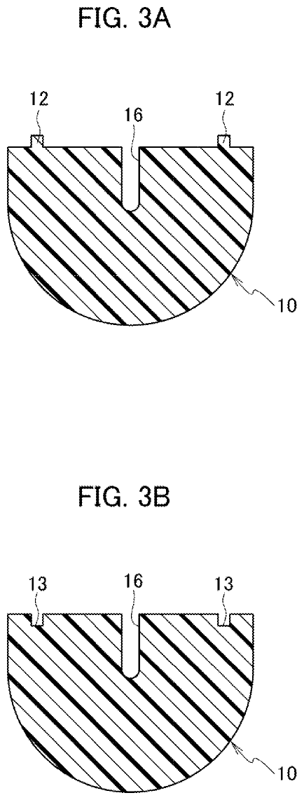

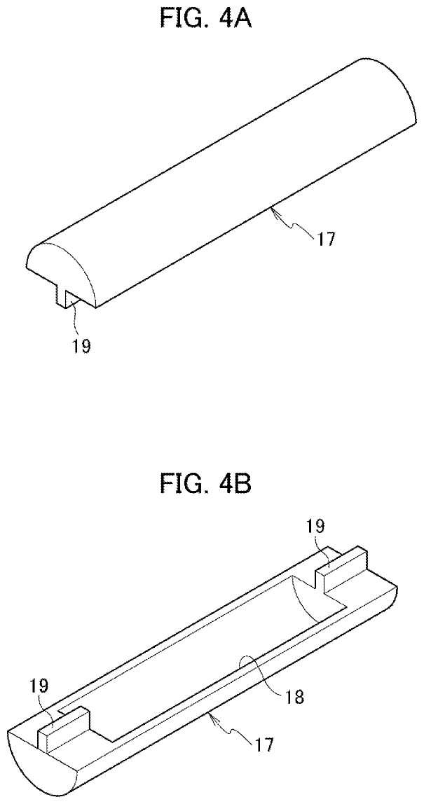

As illustrated in FIG. 2 and FIG. 5, the primary molded body 10 is molded with resin (resin member) in a U-shaped cross section, and has the groove portion 11 formed in a U-shaped cross section that receives the end portions of the electric wires 3, 3, which include the core wire exposed part 5, 5, and the resistor 7 therein. As illustrated in FIG. 3A and FIG. 5, a pair of convex strips 12, 12 is formed protruding on an upper surface of the primary molded body 10 (both sides of an upper surface of the groove portion 11 formed in the U-shaped cross section) such that the convex strips 12, 12 extend along the groove portion 11 and parallel to each other to improve bonding with the secondary molded body 20 (for reinforcing bonding to the secondary molded body 20). The shape to improve bonding with the secondary molded body 20 is not limited to the convex strips 12, 12, and may be concave strips 13, 13 as illustrated in FIG. 3B.

As illustrated in FIG. 2, FIG. 5, and FIG. 6, the groove portion 11 has first receiving sections 11a, 11a, a second receiving section 11b, electric wire holding sections 15, 15, and lead wire holding sections 16, 16. The first receiving sections 11a, 11a, communicate with openings of both ends of the primary molded body 10 via the electric wire holding sections 15, 15, respectively. The second receiving section 11b communicates with the first receiving sections 11a, 11a via the lead wire holding sections 16, 16. Each of the first receiving sections 11a, 11a is formed in a U-shaped cross section, and receives therein a part of the insulation sheath 6 of the electric wire 3 received in the groove portion 11, the core wire exposed part 5, the joint terminal 9, and a part of the lead wire 8 received in the groove portion 11. The second receiving section 11b is formed in a U-shaped cross section, and receives the resistor 7 therein. Each of the electric wire holding sections 15, 15 is formed in a U-shaped cross section, and receives therein a remaining part of the insulation sheath 6 of the electric wire 3 received in the groove portion 11 to hold the insulation sheath 6. Each of the lead wire holding sections 16, 16 is formed in a U-shaped cross section, and receives therein a remaining part of the lead wire 8 received in the groove portion 11 to hold the lead wire 8.

As illustrated in FIG. 5 and FIG. 6, a plurality of arc-shaped concave portions 14 is formed on the primary molded body 10 from both top sides to a bottom side of an outer surface of the primary molded body 10 to improve bonding with the secondary molded body 20 (for reinforcing bonding to the secondary molded body 20).

As illustrated in FIG. 2, FIG. 5, and FIG. 6, the groove portion 11 has the electric wire holding sections 15, 15 on both sides thereof. Widths of the electric wire holding sections 15, 15 are narrower than widths of the first receiving sections 11a, 11a and the second receiving section 11b. The groove portion 11 has the lead wire holding sections 16, 16 on both sides of a middle region thereof. Widths of the lead wire holding sections 16, 16 are narrower than the widths of the first receiving sections 11a, 11a, the second receiving section 11b. and the electric wire holding sections 15, 15.

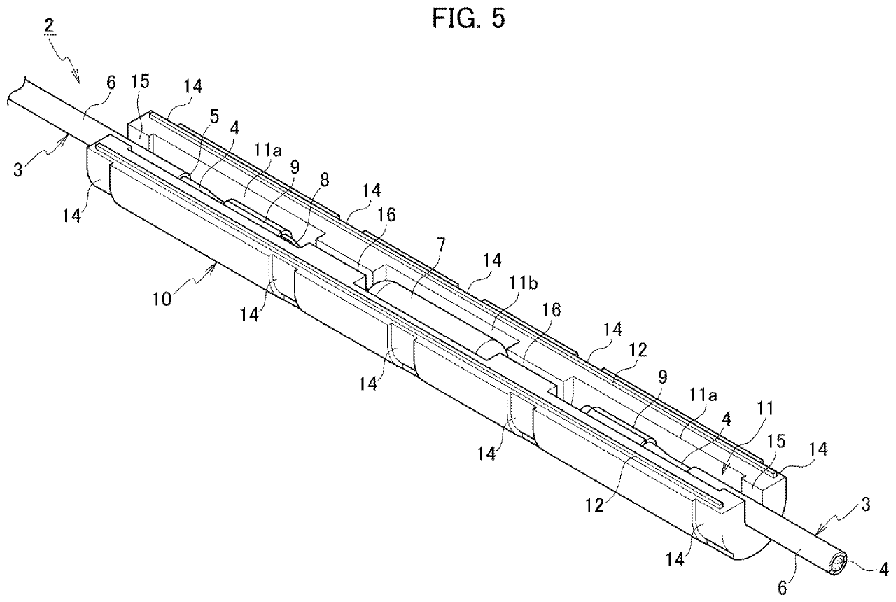

As illustrated in FIG. 6, a protective cap 17 made of resin is mounted to the primary molded body 10. The protective cap 17 covers a part of the middle region of the primary molded body 10 to protect the resistor 7. More specifically, the protective cap 17 covers the second receiving section 11b and parts of the lead wire holding sections 16, 16 adjacent to the second receiving section 11b. As illustrated in FIG. 4A and FIG. 4B, the protective cap 17 is a protective member used for preventing melted resin from contacting the resistor 7, and is formed in a semi-cylindrical shape. The protective cap 17 has a receiving concave portion 18 at a center of a bottom surface thereof. The receiving concave portion 18 receives therein a part of the resistor 7 exposed from the second receiving section 11b. The protective cap 17 further has a pair of engaging convex portions 19, 19 at both sides of the bottom surface thereof. The engaging convex portions 19, 19 are formed protruding on the bottom surface, and fitted in the parts of the lead wire holding sections 16, 16 formed in the U-shaped cross section, respectively.

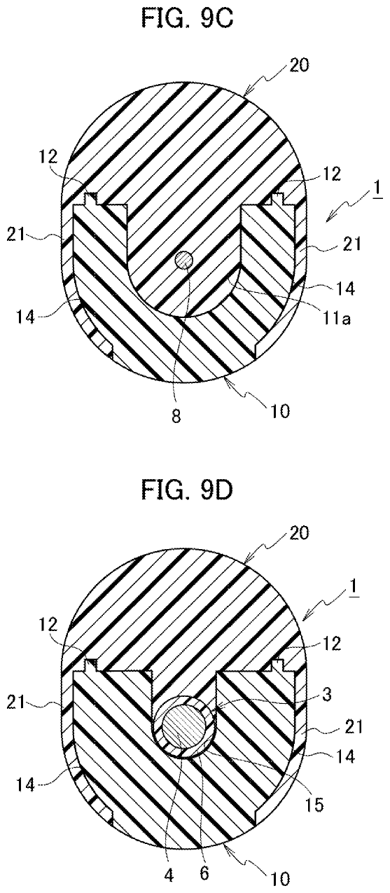

As illustrated in FIG. 8 and FIG. 9A to FIG. 9D, the secondary molded body 20 is molded with resin in a semi-cylindrical shape, and covers the primary molded body 10 in a state where the electric wire assembly 2 is received in the groove portion 11 of the primary molded body 10. When the secondary molded body 20 is molded with resin, resin is injected in the electric wire holding sections 15, 15 formed in the U-shaped cross section and the arc-shaped concave portions 14, which reinforces bonding with the primary molded body 10. A plurality of portions where the resin injected in the arc-shaped concave portions 14 hardens (bonding reinforcement portions) are indicated by a reference number 21 in FIG. 8 and FIG. 9A to FIG. 9D.

Next, a manufacturing procedure of the water-proof structure 1 for electric wire will be described below with reference to FIG. 1, FIG. 2. FIG. 5. FIG. 6 and FIG. 8.

In the manufacturing procedure of the water-proof structure 1 for electric wire, a core wire exposure process is first performed. In the core wire exposure process, the insulation sheath 6 of each of the electric wires 3, 3 is peeled off at the end portion of each of the electric wires 3, 3 to form the core wire exposed part 5 in which the core wire 4 including the plurality of strands 4a is exposed.

Next, as illustrated in FIG. 1, a parts connection process is performed. In the parts connection process, the lead wires 8, 8 of the resistor 7 are connected to the core wire exposed parts 5, 5 of the electric wires 3, 3, respectively. More specifically, the lead wires 8, 8 extending outward from both ends of the resistor 7 are crimped to the core wire exposed parts 5, 5, which are formed at the end portions of the electric wires 3, 3, with the joint terminals 9, 9 such that the lead wires 8, 8 are electrically connected to the core wire exposed parts 5, 5. Thereby, the electric wire assembly 2 is assembled.

Next, a primary molding process is performed. In the primary molding process, the primary molded body 10 illustrated in FIG. 2, which has the groove portion 11 for receiving the end portions of the electric wires 3, 3 including connection portions of the core wire exposed parts 5, 5 and the lead wires 8, 8 of the resistor 7 in the electric wire assembly 2, is molded with resin. In the primary molding process, the protective cap 17 is also produced by molding with resin.

Next, as illustrated in FIG. 5, an electric wire setting process is performed. In the electric wire setting process, the end portions of the electric wires 3, 3, which include the connection portions the core wire exposed parts 5, 5 and the lead wires 8, 8 of the resistor 7 in the electric wire assembly 2, are set in the groove portion 11 of the primary molded body 10. More specifically, each of the first receiving sections 11a, 11a receives therein the part of the insulation sheath 6 of the electric wire 3 received in the groove portion 11, the core wire exposed part 5, the joint terminal 9, and the part of the lead wire 8 received in the groove portion 11. The second receiving section 11b receives the resistor 7 therein. Each of the electric wire holding sections 15, 15 receives therein the remaining part of the insulation sheath 6 of the electric wire 3 received in the groove portion 11. Each of the lead wire holding sections 16, 16 receives therein the remaining part of the lead wire 8 received in the groove portion 11. Here, the remaining part of the insulation sheath 6 of the electric wire 3 is held and fixed in each of the electric wire holding sections 15, 15. The remaining part of the lead wire 8 of the resistor 7 is held and fixed in each of the lead wire holding sections 16, 16. Thereby, the electric wire assembly 2 is set substantially in a straight line within the groove portion 11 of the primary molded body 10.

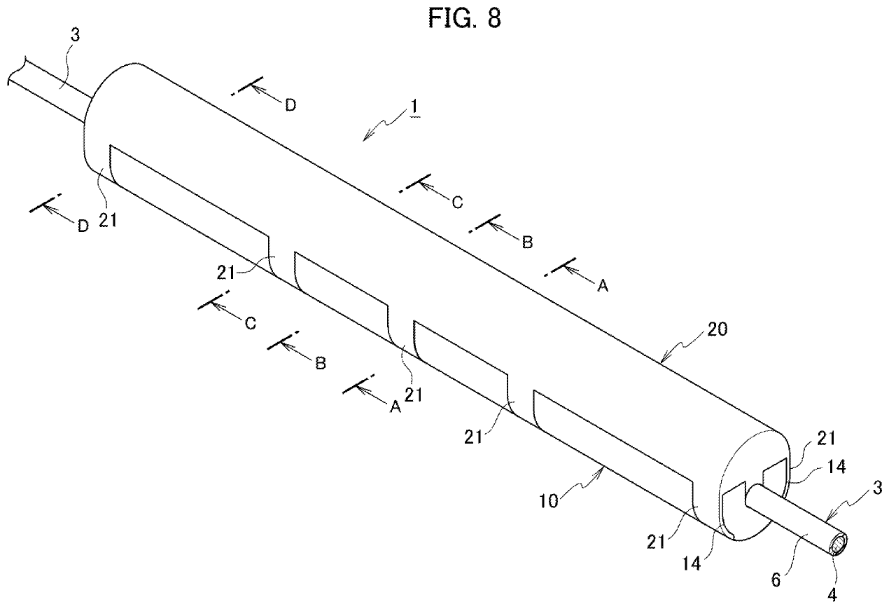

Next, as illustrated in FIG. 6 and FIG. 7, a cap mounting process is performed. In the cap mounting process, the protective cap 17 is mounted to the primary molded body 10 to prevent melted resin from contacting the resistor 7 in a secondary molding. More specifically, the protective cap 17 is mounted to cover the second receiving section 11b of the groove portion 11 by fitting the engaging convex portions 19, 19, which are formed at both sides of the bottom surface of the protective cap 17, in the lead wire holding sections 16, 16.

Finally, as illustrated in FIG. 6 and FIG. 8, a secondary molding process is performed. In the secondary molding process, the end portions of the electric wires 3, 3, which include the connection portions of the core wire exposed parts 5, 5 and the lead wires 8, 8 of the resistor 7 in the electric wire assembly 2, are sealed with resin by molding the resin in the groove portion 11 of the primary molded body 10. As illustrated in FIG. 6, after the primary molded body 10 in which the electric wire assembly 2 is set in the groove portion 11 is fitted into a cavity 33 of a mold 30 consisting of an upper mold and a lower mold, melted resin is injected into the cavity 33 to seal with resin the end portions of the electric wires 3, 3 which include the connection portions of the core wire exposed parts 5, 5 and the lead wires 8, 8 of the resistor 7. When the melted resin hardens, the secondary molded body 20 illustrated in FIG. 8 is completed. At this time, as indicated by the reference number 21 in FIG. 8 and FIG. 9A to FIG. 9D, resin is also injected into the electric wire holding portions 15, 15 and the arc-shaped concave portions 14 in the primary molded body 10 and then hardens, so that the primary molded body 10 and the secondary molded body 20 are firmly bonded. In mold-forming with resin the secondary molded body 20, the resin is injected into a portion which is not covered with the protective cap 17 in the groove portion 11 of the primary molded body 10, and then hardens. The portion includes the first receiving sections 11a, 11a, the electric wire holding sections 15, 15, and a part of each of the lead wire holding sections 16, 16.

Since the electric wire assembly 2 is easily deformed when manufacturing the water-proof structure 1 for electric wire, the groove portion 11 of the primary molded body 10 allows the secondary molding while positioning the electric wire assembly 2 substantially in a straight line to prevent deformation. In addition, the mold-forming with resin in the secondary molding can be performed stably by setting in the groove 11 of the primary molded body 10 the end portions of the electric wires 3, 3 to which the resistor 7 is connected, and holding and fixing the electric wires 3, 3 with the electric wire holding sections 15, 15. In the secondary molding, the resistor 7 is covered with the protective cap 17 to prevent melted resin from contacting the resistor 7, which improves quality. In other words, if the melted resin adheres to the resistor 7, a load on the resistor 7, which is generated in material thermal expansion due to thermal shock, may cause the resistor 7 to break. However, since the melted resin does not flow into the resistor 7 by the protective cap 17, damage due to thermal shock of the resistor 7 can be reliably prevented.

Furthermore, molding with hard resin eliminates a need for conventional protection using the heat-shrinkable tube with a heat-melting water-proofing agent laminated inside the heat-shrinkable tube, which reduces labors and costs and allows use under high temperature conditions. In addition, since the pre-processing is completed simply by setting the electric wire assembly 2 in the groove portion 11 of the primary molded body 10, labor and cost can be reduced.

Thus, in manufacturing the water-proof structure 1 for electric wire, the primary molded body 10 and the secondary molded body 20 can be firmly bonded by dividing the resin molding for water-proofing the connection portions (crimped portions) of the core wire exposed parts 5, 5 of the electric wires 3, 3 and the lead wires 8, 8 of the resistor 7 into two separate processes. This ensures that ingress of water between the electric wires 3, 3 is prevented, thereby improving quality and reducing labors and costs.

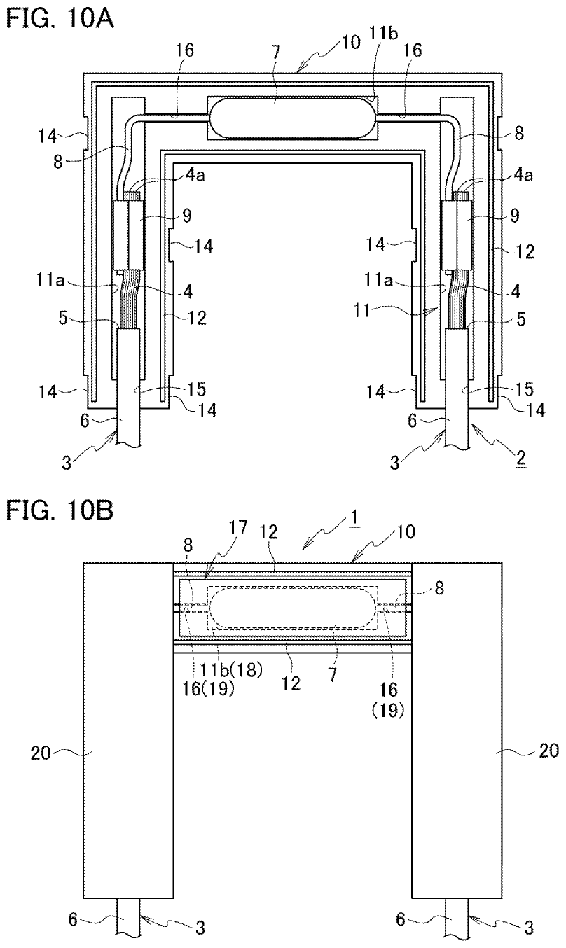

(Modified Example of First Embodiment) The water-proof structure 1 for electric wire in a modified example of the first embodiment differs from the water-proof structure 1 for electric wire in the first embodiment in that the electric wire assembly 2 bent in a substantially U-shape is set in the groove portion 11 of the primary molded body 10 formed in a substantially U-shape, and then the secondary molding with resin is performed (see FIG. 10A and FIG. 10B). Since the other configurations are similar to those of the first embodiment, the same symbols are attached to the same configuration parts and detailed explanations are omitted.

In the modified example, in a state where the lead wires 8, 8 of the resistor 7 each bent in a substantially L-shape are crimped to the core wire exposed parts 5, 5 of the electric wires 3, 3 with the joint terminals 9, 9, the electric wire assembly 2 bent in the substantially U-shape is set in the groove portion 11 of the primary molded body 10 formed in the substantially U-shape, and the resistor 7 is protected with the protective cap 17. Then, the secondary molding with resin to seal is performed with respect to only regions including the core wire exposed parts 5, 5 of the electric wires 3, 3 in the groove portion 11 of the primary molded body 10 formed in the substantially U-shape, and a region including the resistor 7 is covered with the protective cap 17. More specifically, the secondary molding with resin to seal is performed with respect to the first receiving sections 11a, 11a and the electric wire holding sections 15, 15, and the second receiving section 11b and a part of the lead wire holding sections 16, 16 adjacent to the second receiving section 11b are covered with the protective cap 17. This produces the same action and effect as the first embodiment. Especially, since the resistor 7 does not come in contact with the melted resin in the secondary molding, a load on the resistor 7 that occurs during material thermal expansion due to thermal shock is reliably suppressed, and damage to the resistor 7 due to thermal shock can be reliably prevented.

### Second Embodiment

The water-proof structure 1 for electric wire in a second embodiment differs from the water-proof structure 1 for electric wire in the first embodiment in that an intermediate portion of the electric wire 3 in which the core wire exposed part 5 is formed at a part of the intermediate portion by exposing the core wire 4 is set in a groove portion 111 of the primary molded body 10 and an adhesive agent 40 is applied to the core wire exposed part 5, and then a secondary molding is performed. Since the other configurations are similar to those of the first embodiment, the same symbols are attached to the same configuration parts and detailed explanations are omitted.

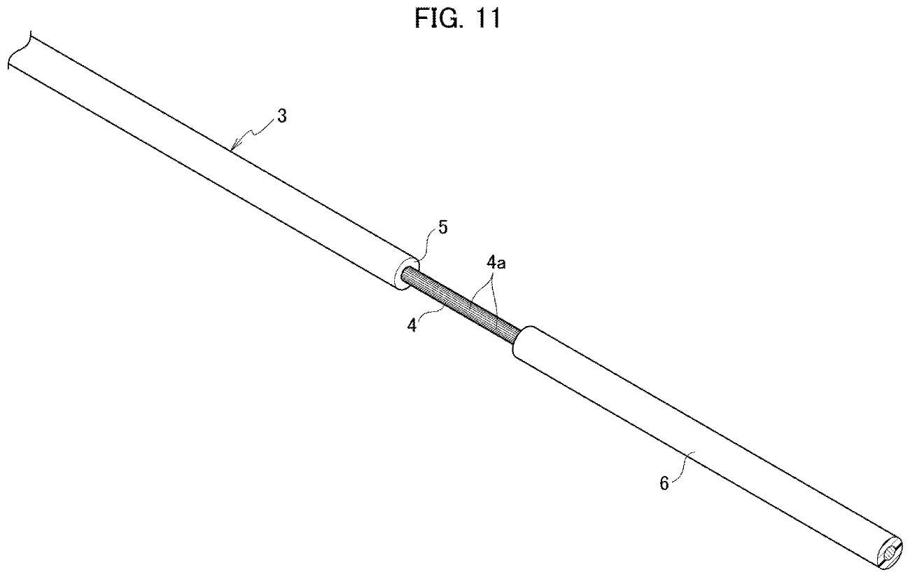

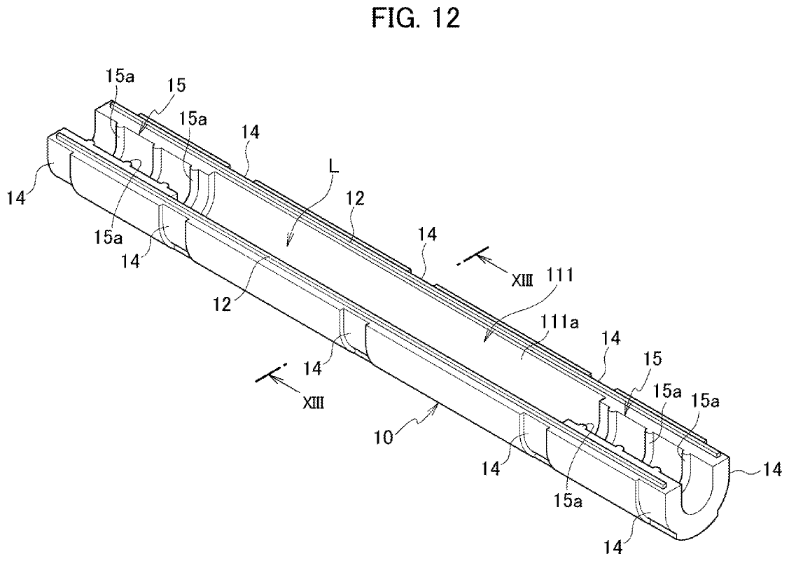

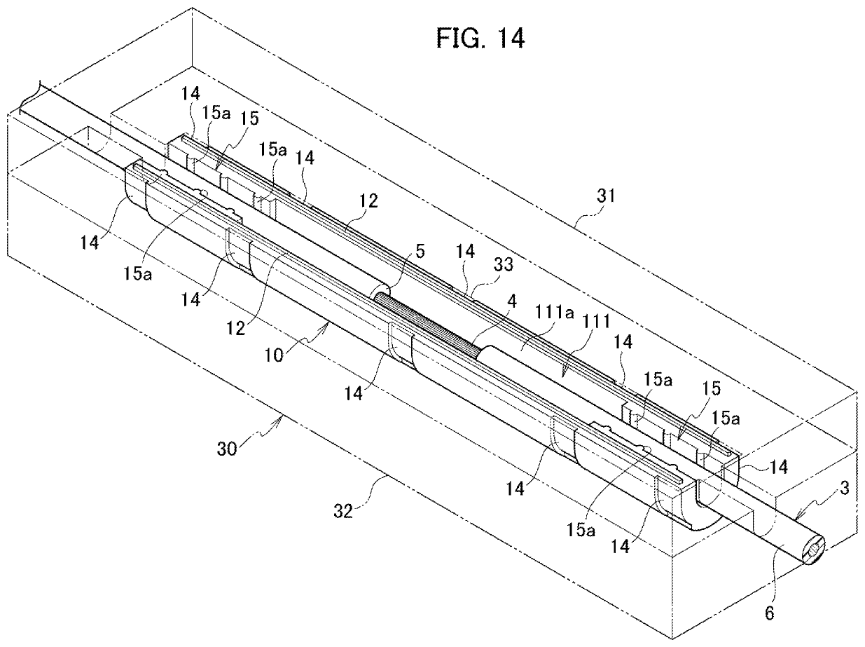

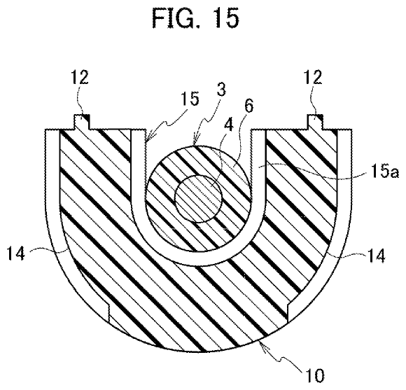

In a manufacturing procedure of the water-proof structure 1 for electric wire in the second embodiment, as illustrated in FIG. 11, a core wire exposure process is first performed. In the core wire exposure process, the insulation sheath 6 of the electric wire 3 is peeled off at the intermediate portion of the electric wire 3 in a length direction of the electric wire 3 to form the core wire exposed part 5 in which the core wire 4 including the plurality of strands 4a is exposed. Next, as illustrated in FIG. 12, a primary molding process is performed. In the primary molding process, the primary molded body 10 which has the groove portion 111 for receiving the intermediate portion of the electric wire 3 including the core wire exposed part 5, is molded with resin. Next, as illustrated in FIG. 14, an electric wire setting process is performed. In the electric wire setting process, the intermediate portion of the electric wire 3 including the core wire exposed part 5 is set in the groove portion 111 of the primary molded body 10. At this time, as illustrated FIG. 14 and FIG. 15, the core wire exposed part 5 of the electric wire 3 and two parts of the insulation sheath 6 adjacent to both sides of the core wire exposed part 5 are received in a receiving section 111a of the groove portion 111 of the primary molded body 10. Another part of the insulation sheath 6 is held and fixed in each of the electric wire holding sections 15, 15. Each of the electric wire holding sections 15, 15 has a plurality of pressing ribs 15a for holding and fixing the another part of the insulation sheath 6. Then, an adhesive agent applying process is performed, In the adhesive agent applying process, the instant adhesive (adhesive agent) 40 is applied to the core wire exposed part 5 set in the groove portion 111 of the primary molded body 10 using a dispenser or other means (not illustrated). The instant adhesive 40 penetrates between the strands 4a of the core wire 4 to seal a gap between the strands 4a. An applied region L of the instant adhesive 40 corresponds to a space of the receiving section 111a between the electric wire holding sections 15, 15 located at both sides of the primary molded body 10.

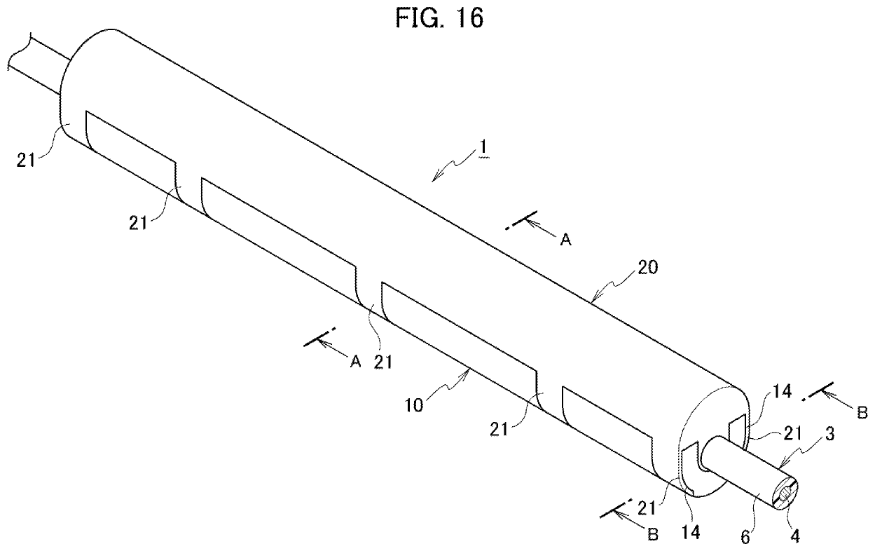

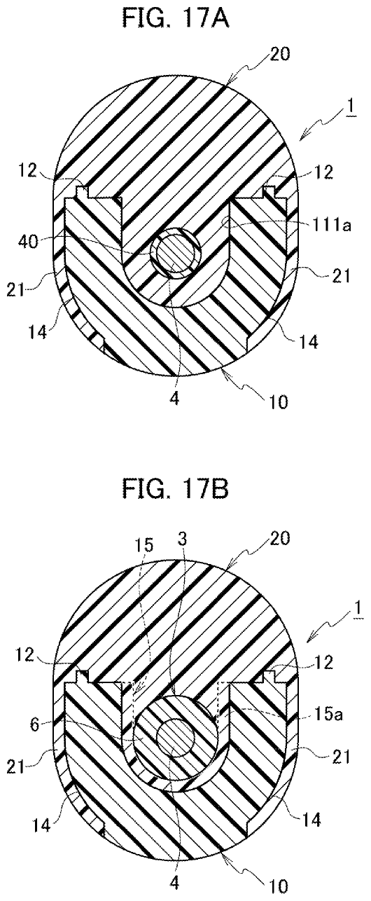

Finally, a secondary molding process is performed. In the secondary molding process, as illustrated in FIG. 14, after the primary molded body 10 in which the intermediate portion of the electric wire 3 is set in the groove portion 111 is fitted into a cavity 33 of a mold 30 consisting of an upper mold 31 and a lower mold 32, melted resin is injected into the cavity 33 to seal with resin the intermediate portion of the electric wire 3 which include the core wire exposed part 5. When the melted resin hardens, the secondary molded body 20 illustrated in FIG. 16 is completed. At this time, as indicated by the reference number 21 in FIG. 16, FIG. 17A and FIG. 17B, resin is also injected into the electric wire holding portions 15, 15 and the arc-shaped concave portions 14 in the primary molded body 10 and then hardens, so that the primary molded body 10 and secondary molded body 20 are firmly bonded. In mold-forming with resin the secondary molded body 20, the resin is injected into the groove portion 111 of the primary molded body 10 and then hardens.

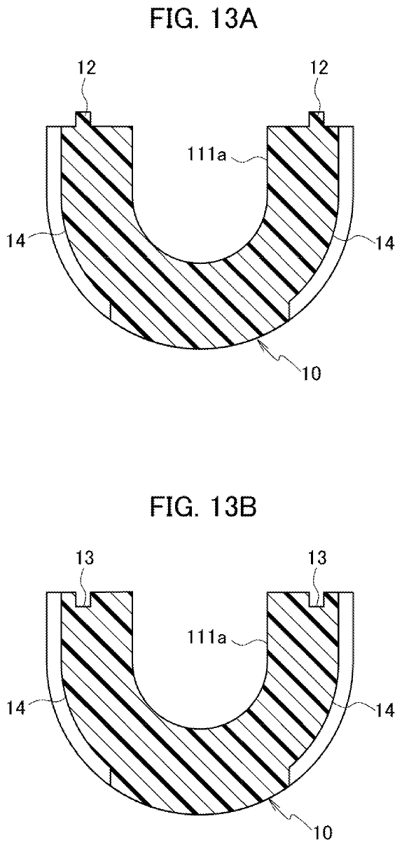

As illustrated in FIG. 12 and FIG. 13A, the pair of convex strips 12, 12 is formed protruding on an upper surface of the primary molded body 10 (both sides of an upper surface of the groove portion 111 formed in the U-shaped cross section) such that the convex strips 12, 12 extend along the groove portion 111 and parallel to each other to improve bonding with the secondary molded body 20 (for reinforcing bonding to the secondary molded body 20). The shape to improve bonding with the secondary molded body 20 is not limited to the convex strips 12, 12, and may be the concave strips 13, 13 as illustrated in FIG. 13B.

Thus, in manufacturing the water-proof structure 1 for electric wire, the primary molded body 10 and the secondary molded body 20 can be firmly bonded by dividing the resin molding for water-proofing between the strands 4a of the core wire exposed part 5 in the intermediate portion of the electric wire 3 into two separate processes. This improves quality and reduces labors and costs. By setting the intermediate portion of the electric wire 3 in which the core wire exposed part 5 is formed at the part of the intermediate portion in the groove 111 of the primary molded body 10, and holding and fixing the intermediate portion of the electric wire 3 with the electric wire holding parts 15, 15, the core wire exposed part 5 can be placed at an axial center position of the secondary molded body 20 formed in a substantially cylindrical shape in the secondary molding. In other words, the intermediate portion of the electric wire 3 can be prevented from being pulled to one side by a flow of melted resin during molding to protrude from the resin molded portion, thereby, preventing the electric wire 3 from being unevenly distributed in the hardened resin to improve quality. Furthermore, a region between the electric wire holding sections 15, 15 located on both sides of the primary molded body 10 can be used as the applied region L of the instant adhesive 40. Therefore, the instant adhesive 40 can be easily and surely applied to the core wire 4, and the instant adhesive 40 can penetrate the gap between the strands 4a to securely seal the gap.

### Modified Example of Second Embodiment

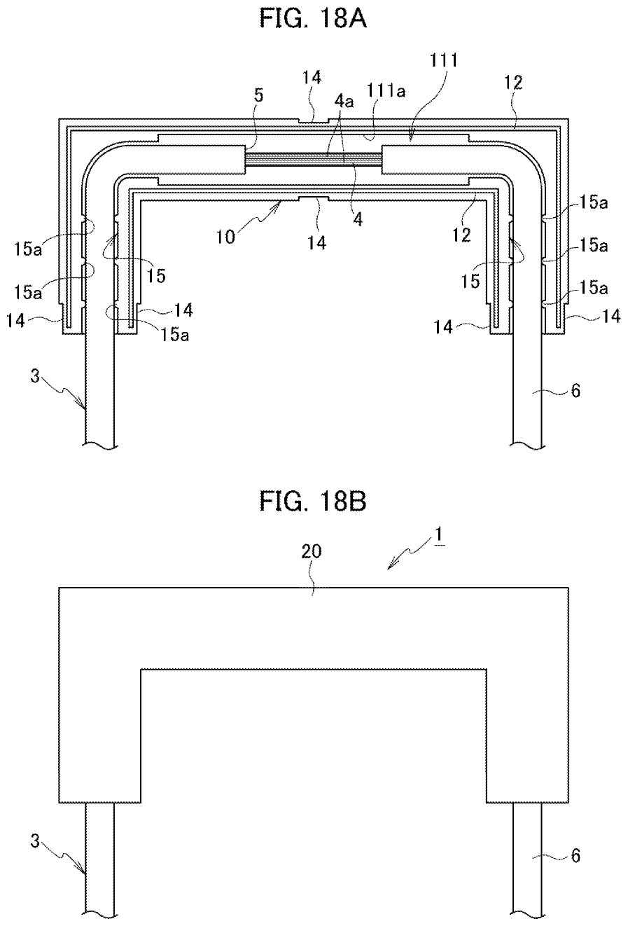

The water-proof structure 1 for electric wire in a modified example of the second embodiment differs from the water-proof structure 1 for electric wire in the second embodiment in that the intermediate portion of the electric wire 3 bent in a substantially U-shape is set in the groove portion 111 of the primary molded body 10 formed in a substantially U-shape, and then the secondary molding with resin is performed after the instant adhesive 40 is applied to the core wire exposed part 5 (see FIG. 18A and FIG. 18B). Since the other configurations are similar to those of the second embodiment, the same symbols are attached to the same configuration parts and detailed explanations are omitted.

In the modified example, the intermediate portion of the electric wire 3 in which each of the parts of the insulation sheath 6 adjacent to the both sides of the core wire exposed part 5 formed at a part of the intermediate portion by exposing the core wire 4 is bent in a substantially L-shape, is set in the groove portion 111 of the primary molded body 10. Then, the secondary molding with resin is performed after the instant adhesive 40 is applied to the strands 4a of the core wire 4 in the core wire exposed part 5. This produces the same action and effect as the second embodiment. Especially, the water-proof structure 1 for electric wire can be installed in a small space.

The above describes the water-proof structure for electric wire and the water-proof method for electric wire according to the embodiments, but those are not limited to the embodiments, and various modification are possible within the gist of the embodiments.

According to the modified example of the first embodiment, the electric wire assembly 2 bent in the substantially U-shape is formed by bending each of the lead wires 8, 8 of the resistor 7 in the substantially L-shape, but the electric wire assembly 2 bent in the substantially U-shape may be formed by bending each of parts of the electric wires 3, 3 adjacent to both sides of the lead wires 8, 8 in a substantially L-shape.

According to the first embodiment, the resistor 7 is used as the electronic component, but the electronic component is not limited to the resistor 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A water-proof structure for electric wire comprising:
an electric wire that includes a core wire exposed part in which a core wire is exposed by peeling off an insulation sheath;
a primary molded body that is molded with resin and includes a groove portion for receiving therein a part of the electric wire, the part of the electric wire including the core wire exposed part; and
a secondary molded body that is molded with resin and covers the primary molded body in a state where the part of the electric wire is received in the groove portion.

2. The water-proof structure for electric wire according to claim 1,
wherein the primary molded body includes one of a convex strip and a concave strip for reinforcing bonding to the secondary molded body, and
the one of the convex strip and the concave strip is formed along the groove portion.

3. The water-proof structure for electric wire according to claim 1,
wherein the groove portion includes an electric wire holding section that has a narrow width and holds the insulation sheath of the electric wire.

4. The water-proof structure for electric wire according to claim 1, further comprising
an electronic component that is connected to the core wire exposed part and is received in a receiving section of the groove portion.

5. The water-proof structure for electric wire according to claim 4,
wherein the primary molded body includes a protective cap that is mounted to the primary molded body such that the protective cap covers the receiving section to protect the electronic component.

6. The water-proof structure for electric wire according to claim 4,
wherein the groove portion includes an lead wire holding section that has a narrow width and holds a lead wire of the electronic component.

7. A water-proof method for electric wire comprising:
peeling off an insulation sheath of an electric wire to form a core wire exposed part in which a core wire is exposed;
connecting a lead wire of an electronic component to the core wire exposed part of the electric wire;
mold-forming with resin a primary molded body including a groove portion for receiving therein a part of the electric wire, the part of the electric wire including a connection portion of the core wire exposed part and the lead wire of the electronic component;
setting the part of the electric wire including the connection portion of the core wire exposed part and the lead wire of the electronic component in the groove portion of the primary molded body; and
mold-forming with resin a secondary molded body such that the resin is injected in the groove portion of the primary molded body to seal with the resin the part of the electric wire including the connection portion of the core wire exposed part and the lead wire of the electronic component.

8. The water-proof method for electric wire according to claim 7, further comprising
mounting a protective cap to the primary molded body such that the protective cap covers a receiving section of the groove portion in which the electronic component is received after setting the part of the electric wire and before mold-forming with resin the secondary molded body.

9. A water-proof method for electric wire comprising:
peeling off an insulation sheath of an electric wire in a part of an intermediate portion of the electric wire in a length direction of the electric wire to form a core wire exposed part in which a core wire including a plurality of strands is exposed;
mold-forming with resin a primary molded body including a groove portion for receiving therein the intermediate portion of the electric wire including the core wire exposed part;
setting the intermediate portion of the electric wire including the core wire exposed part in the groove portion of the primary molded body;
applying an adhesive agent to the core wire exposed part set in the groove portion of the primary molded body such that the adhesive agent penetrates between the strands to seal a gap between the strands; and
mold-forming with resin a secondary molded body such that the resin is injected in the groove portion of the primary molded body to seal with the resin the intermediate portion of the electric wire including the core wire exposed part.
